(19) United States
(12) Patent Application Publication
(10) Pub. No.: US 2016/0372097 A1
(43) Pub. Date: Dec. 22, 2016

(54) WIRELESS MUSICAL INSTRUMENT TUNER

(71) Applicant: Gerald Rogers, Dallas, TX (US)

(72) Inventor: Gerald Rogers, Dallas, TX (US)

(21) Appl. No.: 14/745,734

(22) Filed: Jun. 22, 2015

(51) Int. Cl. G10H 1/44

(52) U.S. Cl. CPC G10H 1/44

(57) ABSTRACT

A computerized system, method and device for assisting in the tuning of a musical instrument to a user identified reference pitch comprising, a vibration sensor attachable to a musical instrument wirelessly connected to a computer device such as an iPhone, Android tablet, Windows phone, or other such smart devices (SD) having a display screen and software for receiving vibration data and computing and displaying the difference between the user input pitch and the instrument vibration frequency computed from the vibration data as, sharp, flat, or in tune, to tune the instrument. The system further provides a choice of either an audio or vibration alert signals for directing the user to increase or decrease the tone of the musical instrument matching the reference pitch enabling even visually impaired musicians who may not be able to visualize the data on a touch screen display of the smart device, to tune their instruments.

### FIELD OF THE INVENTION

The present invention is generally related to devices, systems and methods for tuning a musical instrument. More particularly, the invention relates to a musical instrument tuning device capable of sensing and converting musical instrument vibrations to digital data and displaying the processed data on the screen of a smart device for assisting a musician in tuning their instruments to a reference pitch.

### BACKGROUND OF THE INVENTION

Tuning is the process of adjusting the pitch of one or many tones generated from a musical instrument until these tones form a desired arrangement. Two musical instruments playing the same pitch in unison are void of a beat frequency and therefore need to be tuned to the same beat frequency. Instruments such as the piano or organ have to be tuned by people who are specialists in tuning. For most instruments, however, the players themselves need to tune their instruments before they play. Players of string instruments can turn the pegs at the top of their instruments to change the tension (tightness) of the string. Players of wind instruments can change their instrument's tone very slightly by adjusting the length longer or shorter by pushing out or pulling in, one of the joints. Timpanists turn the taps which are around the top of their instruments to change the tension of the drum head and thus the tone.

In general, tuning any instrument requires the generation of a reference pitch to compare with the pitch of the instrument. This is accomplished by a number of methods from comparing the pitch of the instrument played with the use of a tuning fork resonator at 440 Hertz (Hz) or an electronic pitch generator outputting a 440 Hz pitch through a speaker. The player of the installment matches the tone of the instrument with the 440 Hz tone heard from the tuning fork or electronic pitch generator and adjusts the tone of the “A” pitch of the instrument to the reference frequency of 440 Hz. An orchestra composed of several different instruments, is generally tuned to the frequency of the standard pitch, A above middle C on a piano, defined as 440 Hz endorsed in 1955 by the International Standards Organization (ISO) and reaffirmed by ISO in 1975 as ISO 16:1975 Acoustics Standard tuning frequency (Standard musical pitch). Some orchestras and music organizations deviate a few Hz above or below the ISO standard.

More recently, an electronic instrument with an audio pickup such as a microphone, commonly referred to as the Microphone (MIC) tuner, has been used to listen to the target instrument playing the reference A pitch, comparing the received audio signal with the reference 440 Hz tone and presenting the difference in the tones between the reference pitch generator and that of the instrument to the instrument player, so that the player can adjust the tone of the instrument to reach the reference A pitch.

A tuner used for tuning an electronic instrument plugs into the electrical signal emanating out of the electronic instrument and operates in the same manner as the MIC tuner by comparing the output of the electronic instrument to the reference A pitch and directing the user to adjust the tone output from the electronic instrument to match the reference A pitch. U.S. Pat. Appl. Pub. No. 2014/0345440 (Harvey) operates in conjunction with a wireless amplifier system where the audio signal output of the electric guitars, violins or other instruments is converted to a radio frequency (RF) signal and transmitted to an amplifier with an RF receiver replacing the cable connection between the instrument and amplifier. Harvey ('440) adds a plug-tuning element in parallel to the amplifier input for use in tuning the electric instrument. Plug tuners, including the Harvey ('440) tuner are problematic due to them having to be placed in line with a cable input to an amplifier (s) restricting the placement of the tuner on the floor and operated by the entertainer's foot (foot switch on/off).

The Microphone (MIC) tuners for use with non-electric instruments works well in an environment where one instrument player is tuning only one instrument. Environments where many instruments are played together such as, trios, bands, and orchestras, tuning with a MIC tuner is problematic due to the difficulty in maneuvering the tuner to discriminate the instrument being tuned from the other instruments close by that create similar tones. Clip-on tuners were invented to overcome the problems of the MIC tuner by clipping a tuner on to the body of the instrument and sensing the vibrations in the instrument associated with the tone generation, thus eliminating the problems associated with tuning an instrument among a number of similar instruments playing similar tones.

Clip-on tuners incorporate a mechanical clamp, battery, electronics, a display window and operating keys or buttons to at least power-on and off the tuner. Clip-on tuners attach to the instruments and are held securely in place by the pressure and associated friction of the clamp attached to the instrument. The size and pressure of the clamp is directly related to the weight of the tuner encompassing the battery or batteries and the readable display. Scarred finishes such as dents and scratches are a few reported problems identified with the use of clip-on tuners attached to expensive instruments. U.S. Pat. No. 7,655,851 (Negakura) receives the tone of a musical instrument with the use of a microphone like a MIC tuner or through vibrations like a clip on tuner where the user selects microphone or vibration using a switch on the apparatus containing the microphone and piezoelectric vibration sensor. In this device, the sensor apparatus switched for vibration mode needs to be attached to the guitar or instrument with an adhesive, clamp or screws which would lead to instrument damage. As a result of the reported damages caused to the instruments by the prior art tuner devices and to minimize the associated weight and pressure of these devices on the instruments, the sizes of the clip-on tuners continue to get smaller with less readable displays and smaller batteries, resulting in related reduction in operating time.

More recently, tuner applications have been implemented in software programs on electronic computing devices such as Personal Computers (PC's), Tablets, Personal Digital Assistants (PDA's), Smartphones and similar computing devices referred to generally hereinafter as Smart Devices (SD) using the embedded microphone (MIC) of the SD for receiving the tone from the instrument being tuned and matching the instrument tone with a reference pitch and displaying the results to the user with instructions on how to tune the instrument to the reference pitch. Many free tuner Applications (Apps) are available for download from Smartphone suppliers such as Apple, Microsoft and Google. The Smartphone tuner Apps provide the user with a tuner in an electronic device they carry and use for other tasks, thus avoiding the need to have dedicated tuners. However, these smartphone tuner Apps exhibit the problems MIC tuners show in environments where more than one instrument is being tuned.

Accordingly, there exists a need for a musical instrument tuner device that is considerably small and lightweight so as not to damage and scar a musical instrument as a result of attaching the tuner to the instrument, while at the same time, providing the user the benefit of a separate large display screen found on Smartphones, Tablets and other smart devices to display the data generated by the tuner, to assist musicians to tune their instruments The present invention provides such a device and a system and method for tuning a musical instrument using the device.

### SUMMARY OF THE INVENTION

The present invention is a musical instrument tuner having a sensor that when attached to an instrument, senses the instrument vibrations, converts them into digital data, processes that data into a frequency value, compares the results to a reference pitch, and transmits the data to a smart device such as a Smart Phone, Tablet, PDA or a similar smart device (SD) programmed to communicate with the sensor on the instrument tuner by means of a wireless standard such as Bluetooth, Near Field Communications (NFC) or WIFI direct and displays the data on the screen of a Smart device (SD) as one of, flat, sharp, or in tune. The invention method and system responds to the user tuning the instrument indicating to the tuner if the tuning process is increasing or decreasing the instrument tone output compared to the reference pitch and displaying the results on the SD screen to enable the user to match the tone output from the instrument to the reference pitch and thereby achieving a tuned instrument. The invention tuner software application (App) is developed and made available to the users through the Application Stores such as Google, Apple and Microsoft to mention a few of the most popular distributors of computer device application software for Smart phones, Tablets, Personal Computers (PC's) and Personal Digital Assistants (PDA's). Users identify the invention tuner software application and download and install the application software on their SD's using WiFi, Internet, or cellular networks. The SD's as described herein are not limited to Smart Phones, Tablets, PC's and PDA's but to any computing device with a means for communicating to the user, visually, audibly or through touch.

An exemplary embodiment of the present invention, has a vibration sensor such as an accelerometer, or piezoelectric vibration sensor connected to a Microcomputer powered by a single button battery or small rechargeable battery. The Microcomputer has programming memory, and processing capability for converting the vibration information into digital data. The Microcomputer, using an embedded industry standard Radio Frequency (RF) transceiver, sends the digital data to a computer device having a compatible industry standard RF frequency transceiver. The compatible computer device is programmed with computer instructions to accept user inputs; receive the digital data; process the data identifying the associated frequency; display the data for the user to use in tuning the instrument; and indicate to the user if the instruments tone is above, below, or matches the desired, input reference pitch.

The objects, embodiments, and features of the present invention as described in this summary of the invention will be further appreciated and will become obvious to one skilled in the art when viewed in conjunction with the accompanying drawings, detailed description of the invention, and the appended claims.

### BRIEF DESCRIPTION OF THE DRAWINGS

FIG. 1 is a perspective view of the system configuration of the present invention illustrating a smart device such as a smartphone connected to servers via the Internet and to the tuner sensor through an industry standard wireless communication.

FIG. 2 is a perspective view of the sensor device and smartphone with an application screen shot on the smartphone.

FIG. 3 shows a block diagram of the components used to fabricate the sensor device.

FIG. 4 is a block diagram of the sensor device fabricated with the System on a Chip (SoC) component for minimal power and size.

FIG. 5 is a flow diagram of the system process for installing the application software on the smartphone.

FIG. 6 is a flow diagram of the paring of the smartphone with the sensor and establishing a wireless communications between the two devices.

FIG. 7 is a flow diagram showing the processing of the vibration sensed at the musical instrument and digitized for transmitting to the smartphone.

FIG. 8 is a flow diagram of processing the digitized data for guiding the user to match the tone of the musical instrument to the reference tone.

### DETAILED DESCRIPTION OF THE INVENTION

The present invention is a musical instrument tuning device and a system and method for assisting a musician in tuning their instrument to a reference pitch by means of a wireless standard such as Bluetooth, Near Field Communications (NFC) or WIFI direct. The device of the invention is a tuner having a sensor that is capable of sensing and converting instrument vibrations to digital data and displaying the processed data on the screen of a Smart Device such as a Smartphone, PC Tablet, or other such smart devices (SD's) to apprise the musician whether the tone of the instrument is sharp, flat, or in tune.

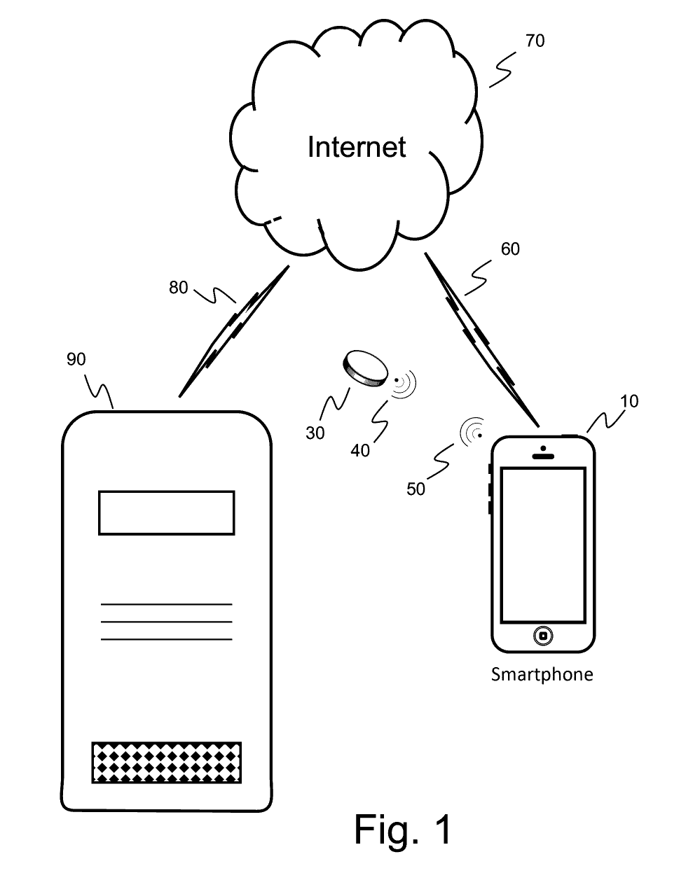

Referring now to FIG. 1, the figure illustrates a perspective view of the system configuration of the invention comprising, a Smart device (SD) such as a Smartphone 10 connected to a Sensor 30 of the instrument tuner by means of an industry standard wireless 40 transceiver in the Sensor 30 and a compatible wireless 50 transceiver in the Smartphone 10. Smartphone 10 is connected to the internet 70 by means of a wireless connection 60 and communicates with a server 90 by means of a wireless connection 80 through the Internet 70. Server 90 can be an application store such as Google, Apple, Microsoft or other third party application providers for computer devices. The system of the invention has its software application residing on server 90 available for the user to transmit and install (download) on their Smartphone 10. The invention application software includes a wireless protocol for identifying Sensor 30 and establishing a communications channel between the Sensor 30 wireless 40 connection and the Smartphone 10 wireless 50 connection, thereby paring the Smartphone 10 and Sensor 30.

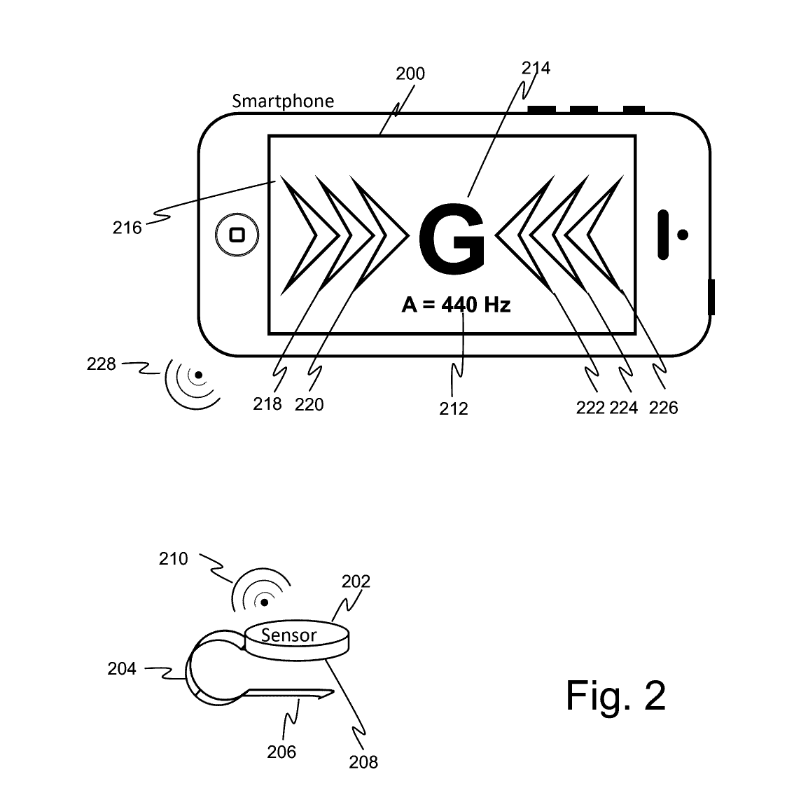

FIG. 2 is a perspective view of the implementation of the present invention showing the Smartphone 10 touchscreen display 200 with the invention application software installed and the Sensor 202 programmed to convert the instrument vibration to a digital format for transmission to the Smartphone 10. Sensor 202 is clamped to an instrument with a clip arm 206 fashioned with a spring 204 attached to Sensor 202. Inserting the instrument between the base 208 of the Sensor 202 and the clip arm 206 with the spring 204 firmly holds the base 208 against the instrument for sensing the vibration of the instrument. Clip arm 206 and the sensor base 208 are coated with a stiction elastomer void of abrasion and chemicals to avoid discoloring or marring the instrument the sensor is attached to. Enclosed within Sensor 202 are electronics for sensing the mechanical vibration; converting the mechanical vibration into an electrical signal; and transmitting 210 the digital data to the Smartphone 10.

In this embodiment of the invention, the Smartphone 10 paired with the Sensor 202 receives digital data transmitted 210 from the Sensor 202's embedded Radio Frequency (RF) transceiver. The Smartphone screen shot 200 indicates to the user, the reference pitch nearest in value to the received frequency value from Sensor 202 and displays the reference pitch named G 214 while simultaneously indicating if the instrument tone is flat by flashing one or more arrows or chevrons 216, 218, and 220 displayed to the left of the reference pitch named G 214 or sharp by flashing one or more arrows or chevrons 222, 224, and 226 displayed to the right of the reference pitch named G 214.

Smartphone 10 displays a reference pitch G 214 indicating that the instrument tone 228 received from Sensor 202 is between 190.418 Hz and 201.7409 Hz and that the instrument is being tuned to reference Pitch G₃ at 195.9977 Hertz based upon ISO 16:1975 displayed on the Smartphone screen shot 200 screen as, A=440 212. Chevrons 216, 218, and/or 220 indicate the installment tone is flat relative to the reference pitch (instrument vibration frequency is less than the reference pitch frequency). The Smartphone screen shot 200 invention software application illuminates chevron 216 when the magnitude of the difference between the reference pitch and the instrument tone is greater than 10 cents (a logarithmic unit of measure used for musical intervals between semi-tones) in terms of frequency less than 194.8688 Hz. Chevron 218 is illuminated for frequencies received less than 10 cents flat (greater than 194.8688 and less than the reference pitch); and chevron 120 is illuminated for frequencies received less than 5 cents flat (greater than 195.4325 and less than the reference pitch). The chevrons 216, 218 and 220 illuminate from right to left as the instrument is tuned from flat to the reference pitch G 214. The reference pitch G 214 and the chevrons 216, 218, 220, 222, 224, and 226 are illuminated with a different color and/or flashing, indicating the instrument is in tune. Tuning an instrument with a tone frequency higher than the reference pitch, defined as sharp, is similar with chevron 226 illuminated for frequencies greater than 10 cents above the reference pitch. Chevron 224 is illuminated for frequencies received less than 10 cents sharp and chevron 220 is illuminated for frequencies received less than 5 cents sharp. The chevrons 226, 224 and 222 illuminate from right to left as the instrument is tuned from sharp to the reference pitch G 214. The reference pitch G 214 and the chevrons 216, 218, 220, 222, 224, and 226 are illuminated with a different color and/or flashing indicating the instrument is in tune.

In this embodiment of the invention, the software system of the invention within the Smartphone 10 enables the user to change the concert pitch A4 from the ISO:16 440 Hz 212 to a range from 410 Hz to 480 Hz and the A=440 212 would be updated to the new concert A. For example, Austria's orchestra tunes to A=432 Hz 212, resulting in G₃ 192.4341 Hz, about 3.5 Hz below G₃ at the ISO:16. The tuning operation with a concert reference frequency of 432 Hz is the same as described for the 440 reference. The parameters are adjusted relative to the change in the reference as described with G₃ reduced by about 3.5 Hz for a concert A equal to 432 Hz.

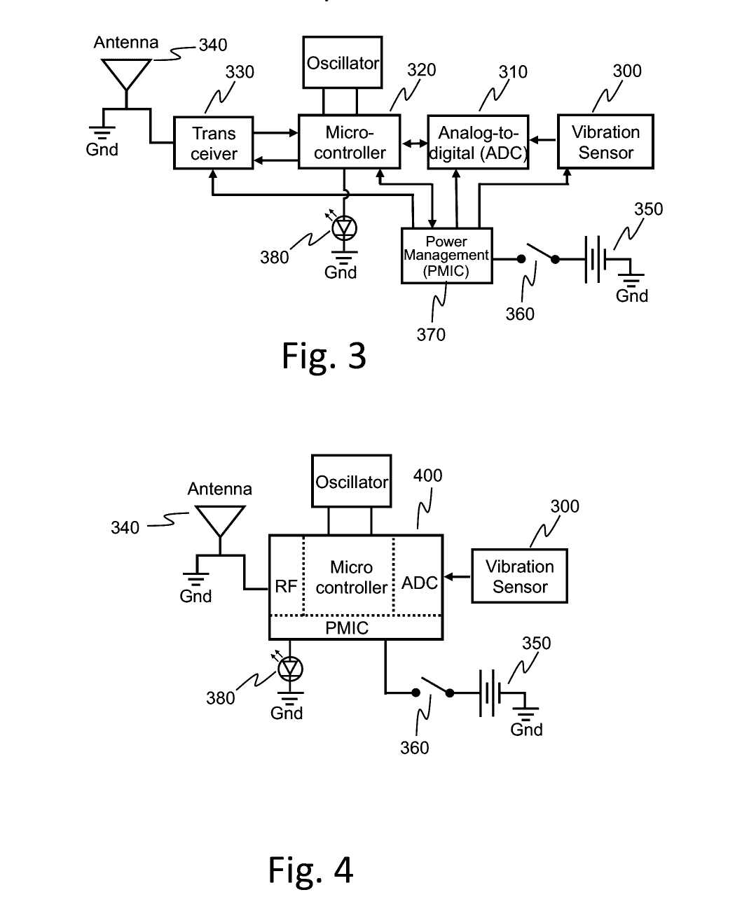

FIG. 3 is a block diagram of the electronics in Sensor 202 showing a vibration sensor 300 used to pick up or sense the instruments tone vibrations and continuously output a current or voltage proportional to the amplitude of the vibration. The output of the vibration sensor 300 can be voltage or current depending upon the technology used in the vibration sensor 300. Vibration sensor 300 is connected to the Analog to Digital Converter (ADC) 310 where the output of the vibration sensor 300 is converted to a digital value to send to the transceiver 330. The ADC 310 samples the output of vibration sensor 300 precisely at a defined frequency interval programmed in the Microcomputer 320 sent to the ADC 310 when activated. The ADC 310 may have a memory buffer for storing the sampled values and signaling mechanisms to indicate to the Microcomputer 320 when converted data is available to be read or sent to the Microcomputer 320.

Microcomputer 320 has program memory, storage memory, timers and processors to control the setup of the ADC 310; receive or read and store the digital data representing the amplitude of the instrument vibrations during tuning; and analyze the digital data determining the instrument's tone frequency in a digital Hertz (Hz) format. Microcomputer 320 activates the Radio Frequency (RF) transmitter in the transceiver 330 and sends the digital frequency value to the transceiver for formatting and subsequent transmission to the Antenna 340 for the Smartphone 10 reception and use.

Continuing with the FIG. 3 block diagram description of the exemplary embodiment of the invention, a battery 350 is connected to a Power Management Integrated Circuit (PMIC) 370 component through a power on/off switch 360. PMIC 370 converts the input voltage from battery 350 to the voltages required for operating the various comments in Sensor 202, Microcomputer 320, ADC 310, vibration sensor 300, and transceiver 330. Different voltages are supplied by the PMIC 370 for different implementations and technology. The PMIC 370 also receives commands from the Microcomputer 320 to turn power-on or off to the vibration sensor 300 and ADC 310 to reduce power consumptions to the minimal, for achieving the maximum battery life.

Sensor 202 paired with a Smartphone 10 will enter a sleep state defined as the state in which minimal power is consumed by the Sensor 202. The RF receiver portion of the transceiver 330 is powered on and listens for a command signal from the Smartphone 10. Once the receiver in the transceiver 330 detects a signal from the Smartphone 10, the receiver sends a signal to the Microcomputer 320 starting a process to sequence the Microcomputer 320 to communicate with the Smartphone 10 sending a status to the Smartphone 10 and receiving operating commands from the Smartphone 10.

A Light Emitting Diode (LED) 380 indicates to the user, the status of the sensor, such as power on, pairing, low battery and other meaningful sensor states. A pressing switch 360 applies power to the vibration sensor 300 illuminating LED 380 and indicating to the user that the sensor 300 is powered on and the transceiver 330 is active, receiving a RF signal at antenna 340 to identify the sensor to the Smartphone 10. Some embodiments of the invention will not have an LED 380 status indicator and in those embodiments, the status function will be programmed in the smart device to indicate to the user, the sensor status on the smart device display.

FIG. 4 is a block diagram depicting an implementation of the invention using the System on a Chip (SoC) is an Integrated Circuit (IC) 400 integrating the analog and digital functions into a single chip. Advances in technology will add the vibration sensor 300 to the SOC 400 thereby reducing the size, weight and cost of the Sensor 202 for integrating the sensor with the instruments during the instrument manufacturing process.

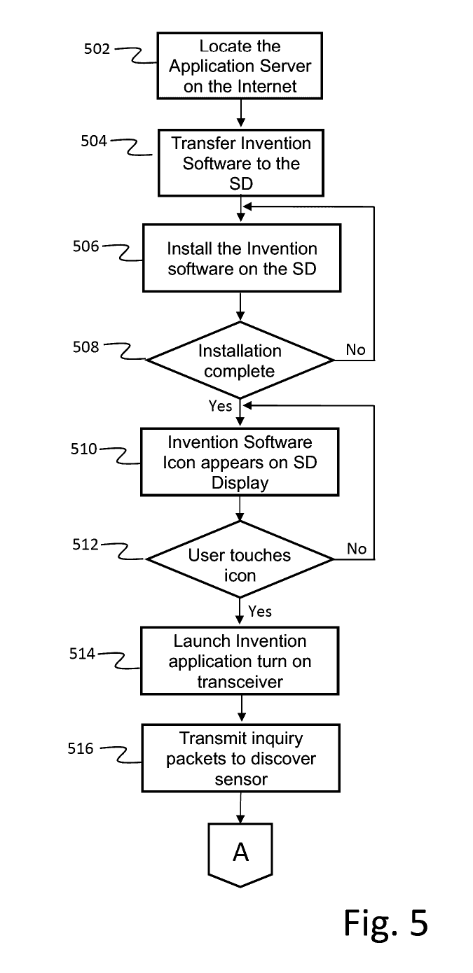

FIG. 5 depicts the steps and the process involved for installing the invention software on a Smartphone 10. The invention software is stored on one or more application servers 90 and made available to the Internet 70 described in FIG. 1. The Flow chart in FIG. 5 box 502 starts with the identification of the invention software on the Internet 70. The user identifies the invention software on the Internet 70 and moves to step 504 where the transfer of the software from the server 90 to the Smart Device (SD) such as a Smartphone 10 by means of the wireless connections 60 and 80 described in FIG. 1 starts. Once the down load of the software to the SD is completed by the application server 90 the process moves to step 506 which is installing the application software on the SD. Once the installation of the software application on the SD is complete in step 508 the invention software icon appears on the SD display in block 510. The invention application rests at block 512 waiting for a user to touch the invention application icon and move to block 514 to launch the invention application and turn on the transceiver. The SD maybe running other application programs while the invention application is idle in block 512. Once the process moves to block 514, the SD launches the application, turning on the wireless transceiver and moves to block 516 to transmit an inquiry RF signal at its antenna to discover, Sensor 30.

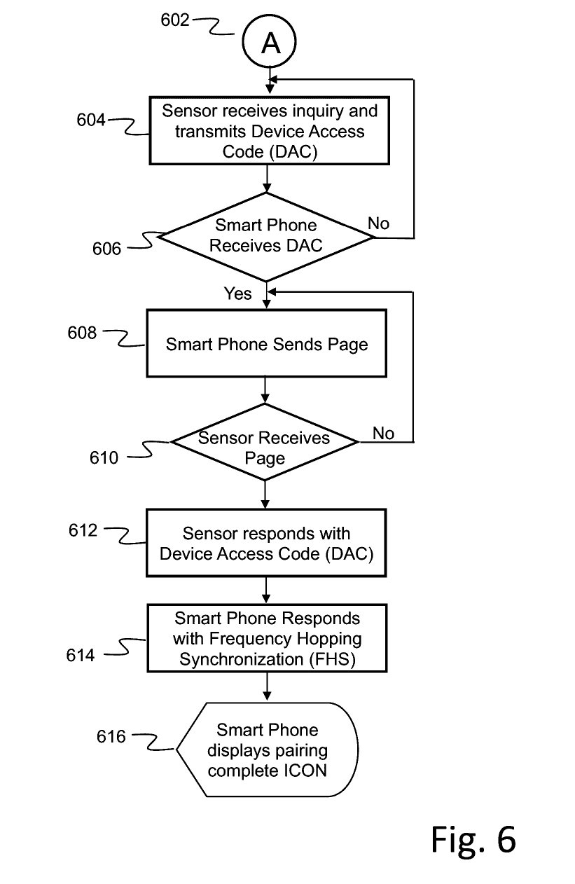

FIG. 6 is a flow diagram depicting the paring of the Smartphone 10 with the Sensor 30 and establishing a wireless communication between the two devices. The flow diagram starts with the process of paring the Sensor 30 to the Smartphone 10. The Sensor 30 receives an inquiry from Smartphone 10 in the inquiry box 604 and transmits a reply with a Device Access Code (DAC) which the Smartphone 10 receives in box 606. The Smartphone 10 transmits a page in box 608 to the active Sensor 30 which receives the page indicating to the Sensor 30 the Radio Frequency (RF) channel to transmit to the Smartphone 10 in box 610. The Sensor 30 responds with a Device Access Code (DAC) in box 612. The Device Access Code (DAC) is a 48 bit code unique to each product similar to a MAC address for Internet/WiFi connected products, with the MAC and DAC being assigned by the IEEE Registration Authority. (The DAC is also referred to as BD_ADDR in Bluetooth literature.). The Smartphone 10 confirms the Sensor 30 DAC and responds with Frequency Hopping Synchronization (FHS) in box 614. At this point, the pairing of the two devices is completed and the Smartphone 10 illuminates an icon on the application screen in box 616. The Smartphone 10 and Sensor 30 are now considered as having bonded, with each device having a link-key stored in memory for subsequent authentications without pairing for a musical instrument tuning procedure.

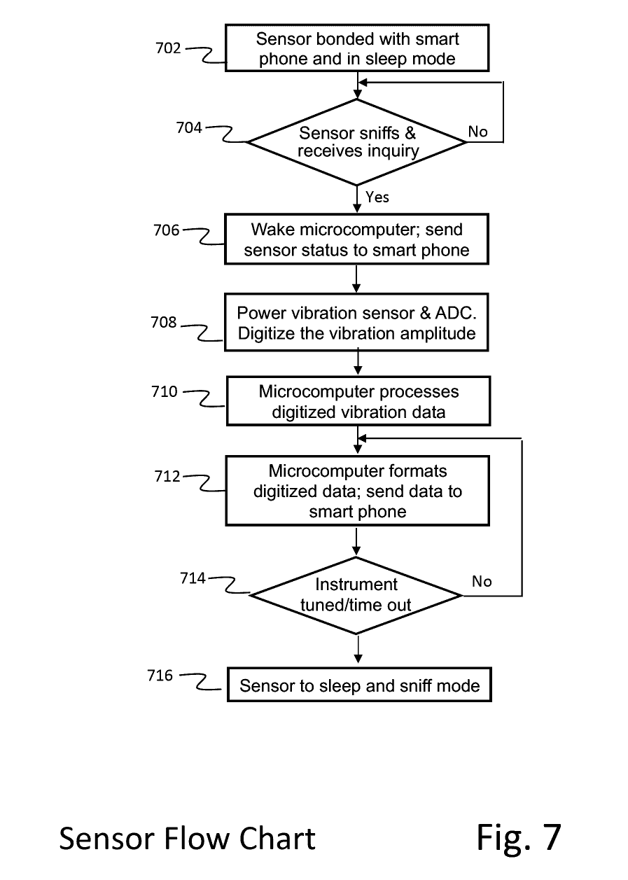

FIG. 7 is a flow diagram showing the processing of the vibration sensed on the musical instrument and digitized for transmitting to the smartphone. The diagram starts with box 702 where the Sensor 30 having bonded and pared with the Smartphone 10 remains idle in the sleep mode and the Power Management Integrated Circuit (PMIC) 370 has powered off all the nonessential components in Sensor 30 that are not required for listening for a Smartphone 10 broadcast signal. Transceiver 330 turns the receiver on, listening for an inquiry signal from the Smartphone 10 and after receiving that signal in box 704 powers up the Sensor 30 components and transmits the status of Sensor 30 to the Smartphone 10 in box 706. The vibration sensor 300 is powered on and detects the musical instruments acoustic vibrations and the ADC 310 is powered on and converts the analog data received from the vibration sensor 300 at a 440,000 Hertz rate, more than ten times the musical instruments fundamental frequency (Percussion, Brass, Woodwinds and String fundamental frequencies are less than 4,000 hertz) in box 708. The Microcomputer 320 reads the digitized data from the ADC 310 and processes the digitized data in box 710. The microcomputer 320 could apply digital signal filters such as band pass or other routines to reduce the data to be transmitted to the Smartphone 10. Microcomputer 320 formats the digitized data and processes the data for transmission to the Smartphone 10 via the transceiver 330 in box 712. The Sensor 30 continues to process the instrument vibration data until either the application sends a stop command indicating the instrument tuning process is completed or the sensor 30 times out in box 714. The Sensor 30 then returns to a sleep mode, waking frequently listening (sniffing) for a broadcast from the Smartphone 10 in box 716.

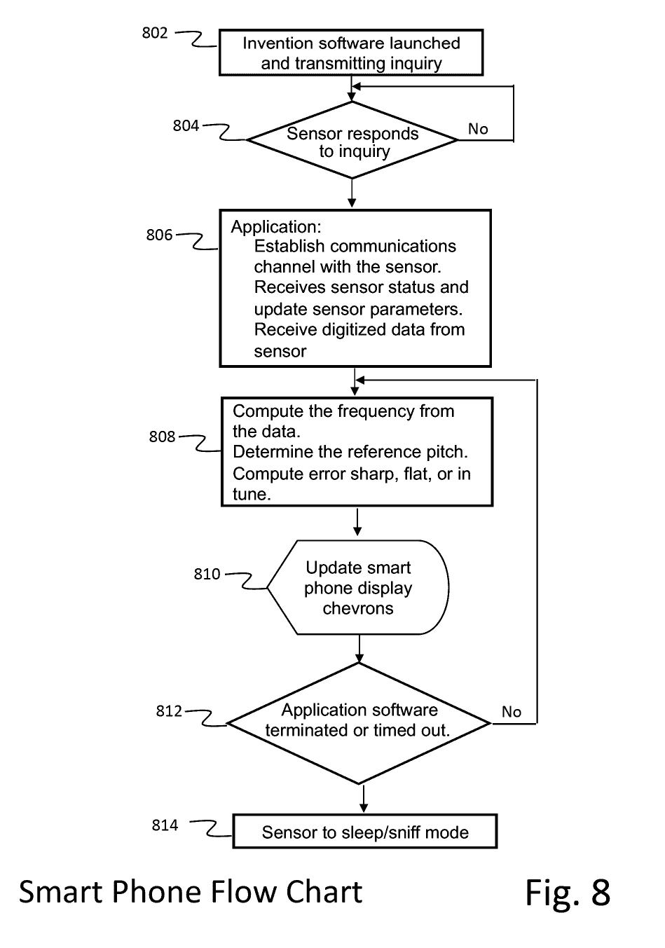

FIG. 8 is a flow diagram depicting the processing of the digitized data for guiding the user to match the tone of the musical instrument to the reference tone. The diagram starts with box 802 with the invention software getting launched and transmitting an inquiry. Sensor 30 acknowledges the inquiry in box 804 and transmits the Device Access Code (DAC) in response to the inquiry. The invention application sends a page (clock synchronization and frequency) establishing a communications channel with the Sensor 10 and once that communications channel is established, the Smartphone 10 receives status from the Sensor 30 and sends required software updates or parameters as required to Sensor 30 in box 806. Communications channel having been established and the Sensor 30 transmitting data, the Smartphone 10 receives the digitized data and starts processing the data with application software algorithms square difference function (SDF), auto correlation function (ACF), Fourier Transform and a combination of all the fore mentioned algorithms to determine the frequency of the digitized vibration data in box 806. The Smartphone 10 computes the difference between the reference pitch and the instruments computed frequency indicating the instrument is sharp with a computed frequency higher than the reference frequency and flat for frequency commuted lower than the reference frequency or in tune in box 808. The Smartphone 10 display chevrons are updated and any errors indicated to the user as to whether the instrument is sharp, flat or in tune in box 810. The user adjusts the tuning of the musical instrument and the Smartphone 10 continuously computes the difference as in box 808 and displays the difference as in box 810 on the smartphone 10 display. The process terminates when the application is closed or the application terminates at the end of a predetermined time of operation in box 812. Application termination sends a command to the Sensor 30 to power down and enter the sleep/sniff mode of operation in box 814.

In addition to the graphical output of the application presented to the user on the Smartphone 10 display, the smartphone audio output and vibration alert output can be programmed to indicate whether the musical instrument tone output is above or below the reference pitch. The audio output of the Smartphone 10 can be programmed to produce an audio output varying the output frequency relative to the computed difference between the Sensor 30 vibration frequency and the reference pitch. For example, when the vibration frequency computed by the Smartphone 10 is lower than the frequency of the reference pitch, the Smartphone 10 outputs an audio frequency ascending as the computed vibration frequency nears the reference pitch and descends as the computed frequency widens the difference between the computed vibration frequency in response to the change in the musical instrument that is tuned. Smartphone 10 would beep or otherwise signal the user when the musical instrument matches the reference pitch.

The Smartphone 10 vibration alert will be similar to the audio output, with the Smartphone 10 increasing or decreasing the vibration of the Smartphone 10 relative to the computed vibration frequency's difference from the reference pitch. Both the audio and vibration alert signals for directing the user to increase or decrease the tone of the musical instrument matching the reference pitch can be used by visually impaired musicians as well as musicians that do not want to use the display of the Smartphone 10. A musician can leave the Smartphone 10 in a pocket and feel the vibration for tuning the instrument or wear an earpiece or Bluetooth earpiece to receive audio clues for tuning the instrument.

While the present invention has thus been described in connection with its exemplary embodiments, it should be understood and obvious to one skilled in the art that alternatives, modifications, and variations of the embodiment of the present invention may be construed as being within the spirit and scope of the appended claims.

1. A device for tuning a musical instrument, said device comprising:
a vibration sensor with a means for receiving a vibration output from a musical instrument;
said vibration sensor comprising an analog to digital converter for converting said vibration output from said musical instrument to a digital value that represents the amplitude of said musical instrument vibrations during tuning;
said vibration sensor comprising a microprocessor for receiving said digital value that represents the amplitude of said musical instrument vibrations from said analog to digital converter;
wherein said microprocessor, stores, processes and analyzes said digital value to determine said instrument's vibration frequency and transmits said vibration frequency digital value to a computer device through a wireless transceiver located within said vibration sensor; and
wherein a processor of said computer device compares and calculates a difference between said vibration frequency digital value of said musical instrument and a reference pitch value incorporated within said processor of said computer device and displays said difference between said vibration frequency digital value of said musical instrument and a reference pitch value as, sharp, flat, or in tune on said computer device display screen.

2. A system for tuning a musical instrument said system comprising:
a vibration sensor module for receiving and transmitting a digitized vibration output from said musical instrument:
a computer device for receiving said digitized vibration output of said musical instrument from said vibration sensor module; and
wherein a program within said computer device outputs an audio signal of varying audio frequencies related to the difference between a computed vibration frequency of said musical instrument and a reference pitch as one of sharp, flat or in tune for adjusting a tone of said musical instrument to said reference pitch.

3. The system as described in claim 2 wherein the program within said computer device activates a vibration alert output related to the difference between said computed vibration frequency of said musical instrument and said reference pitch providing a vibration output with varying vibrations per second indicating sharp, flat, or in tune to the user for adjusting the tone of the musical instrument.

4. A processor with a computer readable storage medium having executable program instructions for said processor to activate and operate a remote vibration sensor in a low power manner;
said processor determining a frequency of a vibration data received from said remote vibration sensor;
said processor calculating a difference between a computed vibration frequency and a reference pitch frequency; and
said processor graphing on a display screen of a computer device said difference between said computed vibration frequency and said reference pitch frequency.

5. A processor with a computer readable storage medium having executable program instructions as recited in claim 4 wherein said processor having executable program instructions to modulate an audio output of a computer device relative to a difference between said computed vibration frequency and said reference pitch.

6. A processor with a computer readable storage medium having executable program instructions as recited in claim 4, said processor having executable program instructions to activate and control a vibration alert output of a computer device signaling a difference between said computed vibration frequency and said reference pitch.

7. A system for detecting a vibration from a musical instrument and transmitting a vibration data wirelessly to a receiving computer device for use in computing and producing a difference between a vibration frequency of a musical instrument and a reference pitch, comprising:
a vibration detection module attachable to said musical instrument;
said vibration detection module having a vibration sensor;
an analog-to-digital converter connected to said vibration sensor to convert an output of a vibration from said musical instrument and digitize an amplitude of said vibration;
a microcomputer with a readable storage medium having an executable code for receiving said digitized vibration amplitude data from said analog-to-digital converter;
a radio frequency transceiver connected to said microcomputer receiving a formatted digitized vibration data from said microcomputer and transmitting said formatted digitized vibration data to a computer device programmed to receive said digitized vibration data from said vibration detection module; and
a computer device determining reference pitch and calculating a difference between said reference pitch and said vibration frequency computed from said vibration data and displaying said difference on said computer device display screen.

8. The system for detecting the vibration from a musical instrument as recited in claim 7, further comprising an audible output indicating to the user the difference between the vibration data and the identified reference pitch using varying audio frequencies indicating sharp, flat or in tune to the user.

9. The system for detecting the vibration from a musical instrument as recited in claim 7, further comprising a vibration alert output indicating to the user the difference between the vibration data and the identified reference pitch using varying vibrations per second indicating sharp, flat or in tune to the user.

10. The system for detecting the vibration from a musical instrument as recited in claim 7, wherein said vibration sensor receives an inquiry from a computer device and transmits a device access code to said computer device to pair said vibration sensor to said computer device.

11. The system for detecting the vibration from a musical instrument as recited in claim 7, wherein the process of tuning said instrument starts with a computer device that is paired with the vibration sensor sending an inquiry signal to the vibration sensor to power on the vibration sensor to detect the instrument's acoustic vibrations and send the said acoustic vibrations to said analog to digital converter within said vibration detection module, wherein said analog to digital convertor digitizes said instrument's acoustic vibration amplitude which is processed and formatted by said microcomputer within said vibration detection module and sent to a computer device by said radio frequency transceiver, said computer device computes a difference between a reference pitch and said instrument's computed frequency pitch and displays said difference as one of sharp, flat, or in tune on said computer device display screen.

12. The system for detecting the vibration from a musical instrument as recited in claim 7, wherein said computer device is one of a smart phone, tablet, and other smart devices.
